(19) United States
(12) Patent Application Publication
(10) Pub. No.: US 2020/0086583 A1
(43) Pub. Date: Mar. 19, 2020

(54) Welding And Consolidation Of Thermoplastic Composites Using Vacuum Bagging, Air Cooling And Induction

(71) Applicant: University of South Carolina, Columbia, SC (US)

(72) Inventors: Burton L. Rhodes, JR., Columbia, SC (US); Michael Van Tooren, Elgin, SC (US)

(73) Assignee: University of South Carolina, Columbia, SC (US)

(21) Appl. No.: 16/569,760

(22) Filed: Sep. 13, 2019

Related U.S. Application Data
(60) Provisional application No. 62/730,601, filed on Sep. 13, 2018.

(51) Int. Cl. B29C 65/36; B29C 65/00

(52) U.S. Cl. CPC B29C 65/3668; B29K 2101/12; B29C 66/721

(57) ABSTRACT

A method for simple and economical positioning of two work pieces with one another wherein the pieces are welded using induction heating to melt a polymer in a composite wherein air can be blown on the surface to limit the welding to an area close to the mating surface of the work pieces and to prevent melting of the outer surface which would deteriorate the quality of the outer surface.

### BACKGROUND OF THE INVENTION

### 1) Field of the Invention

The present invention relates to a method for simple and economical positioning of two work pieces with one another wherein the pieces are welded using induction heating to melt a polymer in a composite. Air can be blown on the surface to limit the welding to an area close to the mating surface of the work pieces and to prevent melting of the outer surface which would deteriorate the quality of the outer surface.

### 2) Description of Related Art

Discovered by Michael Faraday, induction starts with a coil of conductive material (for example, copper). As current flows through the coil, a magnetic field in and around the coil is produced. The ability of the of the magnetic field to do work depends on the coil design as well as the amount of current flowing through the coil. FIG. 1 shows a magnetic field 100 represented as lines passing through and around coil 102.

The direction of the magnetic field depends on the direction of current flow, so an alternating current through the coil will result in a magnetic field changing in direction at the same rate as the frequency of the alternating current. 60 Hz AC current will cause the magnetic field to switch directions 60 times a second. 400 kHz AC current will cause the magnetic field to switch 400,000 times a second.

When a conductive material, a work piece, is placed in a changing magnetic field (for example, a field generated with AC), voltage will be induced in the work piece (Faraday's Law). The induced voltage will result in the flow of electrons: current. The current flowing through the work piece will go in the opposite direction as the current in the coil. This means that one can control the frequency of the current in the work piece by controlling the frequency of the current in the coil.

As current flows through a medium, there will be some resistance to the movement of the electrons. This resistance shows up as heat (The Joule Heating Effect). Materials that are more resistant to the flow of electrons will give off more heat as current flows through them, but it is certainly possible to heat highly conductive materials (for example, copper) using an induced current. This phenomenon is critical for inductive heating.

Induction welding is a form of welding that uses electromagnetic induction to heat the work piece. The welding apparatus contains an induction coil that is energized with a radio-frequency electric current. This generates a high-frequency electromagnetic field that acts on either an electrically conductive or a ferromagnetic work piece. In an electrically conductive work piece, the main heating effect is resistive heating, which is due to induced currents called eddy currents. In a ferromagnetic work piece, the heating is caused mainly by hysteresis, as the electromagnetic field repeatedly distorts the magnetic domains of the ferromagnetic material. In practice, most materials undergo a combination of these two effects.

Nonmagnetic materials and electrical insulators such as plastics can be induction-welded by implanting them with metallic or ferromagnetic compounds, called susceptors, that absorb the electromagnetic energy from the induction coil, become hot, and lose their heat to the surrounding material by thermal conduction. Plastic can also be induction welded by embedding the plastic with electrically conductive fibers like metals or carbon fiber. Induced eddy currents resistively heat the embedded fibers which lose their heat to the surrounding plastic by conduction. For instance, induction welding of carbon fiber reinforced plastics is commonly used in the aerospace industry.

It is not only the fibers that are heating up and transferring heat to the polymer. There is also contact heating at positions where fibers in different directions in adjacent plies touch, and, most important, there is joule heating of the polymer itself which becomes considerable if the polymer layer surrounding each fiber becomes very thin. This means at high fiber volume fractions the current is actually flowing through the polymer and causes the main part of the heating. Last there is dielectric heating for polymers that have sufficient asymmetry to interaction between (high frequency) electromagnetic waves and their asymmetric electric charge distribution.

Induction welding is used for long production runs and is a highly automated process, usually used for welding the seams of pipes. It can be a very fast process, as a lot of power can be transferred to a localized area, so the faying surfaces melt very quickly and can be pressed together to form a continuous rolling weld.

The depth that the current, and therefore heating, penetrates from the surface is inversely proportional to the square root of the frequency. The temperature of the metals being welded and their composition will also affect the penetration depth. This process is very similar to resistance welding, except that in the case of resistance welding the current is delivered using contacts to the work piece instead of using induction.

For example, tubes can be welded by inducing a current in a tube along the open seam. The edges are heated to a temperature high enough for welding. Then the seam edges are forced together. The induction welding process can be done quickly; a lot of power can be localized so the faying surfaces melt quickly and can form a continuous rolling weld when pressed together. Again, temperature and metal composition will affect penetration depth.

Induction welding of composite parts is currently very expensive and involves heavy, cumbersome tools. The associated very high, non-recurring costs hamper the application of induction welding in the composite structure industry. Accordingly, it is an object of the present disclosure to provide an improved method of welding of thermoplastic composites using vacuum-bagging, air-cooling and induction.

### BRIEF SUMMARY OF THE INVENTION

The above objectives are accomplished according to the present disclosure by providing in a first embodiment, a noninvasive method for welding pieces to one another. The method may include placing at least two work pieces in contact with one another, enclosing an area containing the at least two work pieces, placing pressure on the at least two work pieces in contact with one another, induction heating a weld area formed where the at least two work pieces contact one another, and blowing air onto a surface of the work pieces. Further, an outer surface of the work pieces may be unaffected by the welding. Yet still, pressure may be created by forming vacuum pressure in the area containing the at least two work pieces. Again, the pressure may be generated by enclosing the area containing the at least two work pieces within a container. Yet again, the container may be a vacuum bag. Furthermore, at least one susceptor may be contained within at least one work piece. Still further, the at least one susceptor may be ferromagnetic or nonferromagnetic. Yet again, an induction coil may be moved over the area enclosing the at least two work pieces. Further, the induction coil may not come into contact with the weld area. Still yet, a vacuum seal may be formed in the area enclosing the at least two work pieces. Further still, post-welding, the joined pieces may be exposed to a second injunction heating to provide substantially full consolidation.

In a further embodiment, a system for induction welding pieces to one another is disclosed. The system may include an air source, a device for creating a vacuum, an enclosing container, a support surface, and an induction coil. Further, an outer surface of work pieces being welded to one another may be unaffected by induction welding. Still further, pressure may be created by forming vacuum pressure in the enclosing container. Again, the enclosing container may be a vacuum bag. Still yet, at least one work pieced being welded may comprise a susceptor. Further yet, the at least one susceptor may be ferromagnetic or nonferromagnetic. Still, the induction coil may be moved over the area enclosing the at least two work pieces. Yet again, the induction coil may remain at a distance from the weld area formed by the system. Still further, a vacuum seal may be formed in the area enclosing the at least two work pieces.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows an illustration of a magnetic field and induction coil.

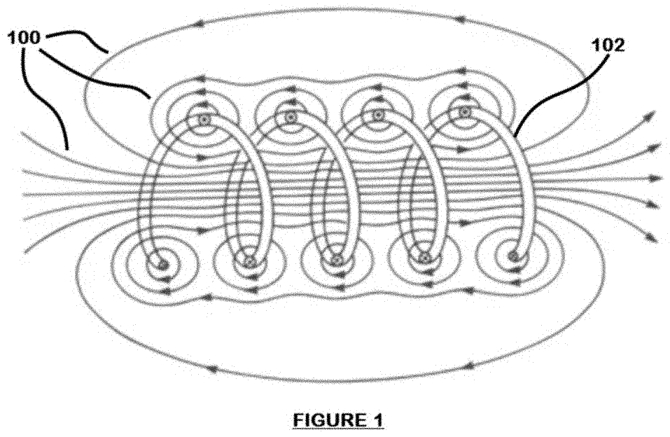

FIG. 2 shows an illustration of two pieces being welded to form a joint within a vacuum bag with air applied.

FIG. 3 shows a method of vacuum assisted induction welding.

FIG. 4 shows another embodiment of the current disclosure.

FIG. 5 shows an example welding set up for the current disclosure.

FIG. 6 shows an example welding process of the current disclosure.

FIG. 7 shows laminate weld progression as an induction coil moves across unconsolidated lamina.

FIG. 8 shows a typical temperature profile for a process of the current disclosure.

FIG. 9 shows a representative air cooling diagram of the current disclosure.

FIG. 10 shows tuning of a stacking sequence to focus heating as well as focused heated in perpendicular stacking.

FIG. 11 shows various examples of how the process of the current disclosure may be employed to create different heating profiles.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

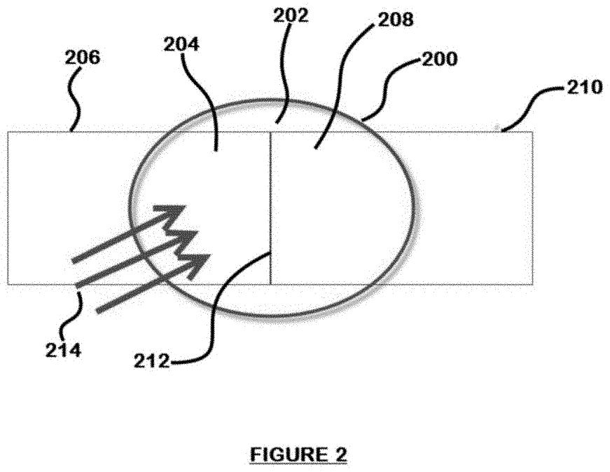

Welding of thermoplastic composites needs both pressure and temperature. The pressure can be generated using compaction rollers or mechanical pressure from a tool block or a pressurized tube/bag. Pressure may be imparted up to one atmosphere of pressure, such as from 0.1 to 1.0 atmosphere, from 0.5 to 1.0, from 0.5 to 0.75, etc. The vacuum may be generated by vacuum pumps typical of use in the composites manufacturing industry. For the current disclosure, as shown by FIG. 2, pressure is created using a container 200, for purposes of example only and not intended to be limiting, a vacuum bag, that encloses a weld area 202, comprising a first weld section 204 of first piece 206 and second weld section 208 of second piece 210 to be welded to one another to form weld 212. Use of vacuum pressure also removes entrapped gases to reduce porosity and improve consolidation of the weld. The invention allows for air, illustrated by arrows 214, to be blown onto the outer surfaces of the work pieces 206 and 210. The air may be compressed air, compressed gas, such as N₂ or O₂, etc. This active cooling allows for control of the weld pool to protect outer surface quality and prevent material squeeze. Material squeeze is undesired as it may result in deformation of the part and change the fiber volume fraction leading to reduction in desired mechanical properties. In one embodiment, air may be blown on a vacuum bag. This will cool the bag and allows bag material to be used that is of lower melting temperature than the polymer in the work pieces. It also can cool the surface of the work pieces to maintain a previously obtained consolidated state. In case of full consolidation to be obtained while welding, the temperature also of the outer layer of the laminate needs to be melted and the bag needs to be able to sustain a temperature higher than the melting temperature of the work pieces. At the weld zone there is overlap between work pieces There can be bridging of the bag when it goes from one work piece to the other. The bridging will cause the polymer to be squeezed out of a work piece when the polymer melts. In one instance, welding may be done using induction either by heating the carbon fibers, or any other suitable fiber, in the composite directly or by heating a separate susceptor in the joint area. Fiber angles in a work piece are primarily defined by the mechanical requirements on the work piece. If the carbon fibers in the work pieces are used as the susceptors, then this will only work at the zones in the plies around the interfaces between plies with different fiber directions. Carbon fibers may come preimpregnated in the lamina/laminates from the material supplier. The lamina/laminates may be placed using standard composite manufacturing processes including hand layup, automated fiber placement, or 3-D printing.

Any change in fiber direction will work. The best angle difference between plies for heating is 90 degrees. But this is unfavorable for mechanical strength. 45 degree's difference works as well. Further, laminates consisting of [0/45/90]s and any variation of this work well. But again as long as there are angle differences there will be heating. Thus, the current disclosure embodies and discloses angle measurement between respective fibers ranging from 0-90 degrees, such as 10, 15, 20, 25, 30, 35, 40, 50, 55, 60, 65, 70, 75, 80, 85, and variations between these angles, etc.

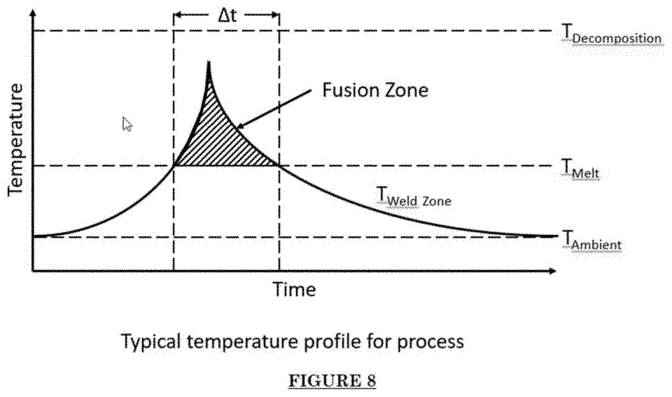

In a further embodiment, a lapjoint may be created between thermoplastic plates by covering the plates to be welded with a plastic bag that is sealed (vacuum bagging technique). An induction coil is moved over the bag (non-contact) to weld the plates. The surface can be actively cooled with air during welding to prevent surface quality detonation. Distance of the coil may depend upon the strength of the magnetic field. Larger distances (while still able to melt the material) allow for lower sensitivity to coil orientation changes. Typical distances are up to 100 mm from the weld zone, preferred distances are within 25 mm. But distance from 1-100, such as 10, 15, 20, 30, 40, 45, 50, 55, 60, 65, 70, 75, 80, 85, 90 and 95, as well as variations between these amounts are herein disclosed. Movement speed(s) of the coil during welding are material dependent but should allow for diffusion of the thermoplastics to facilitate fusion. Typical constraints are time and temperature such that the thermoplastic is above the melt temperature for a certain time without exceeding the decomposition temperature. See FIG. 8, which shows a typical temperature profile for a process of the current disclosure.

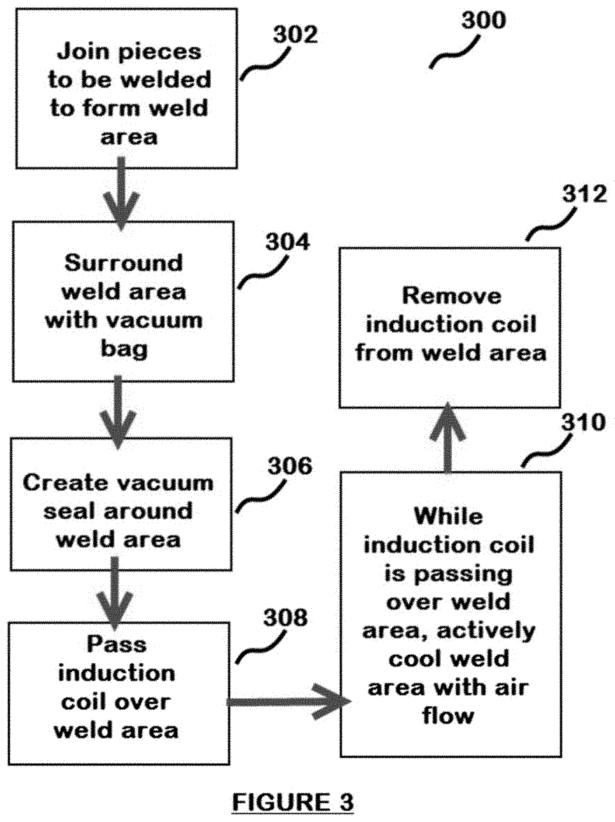

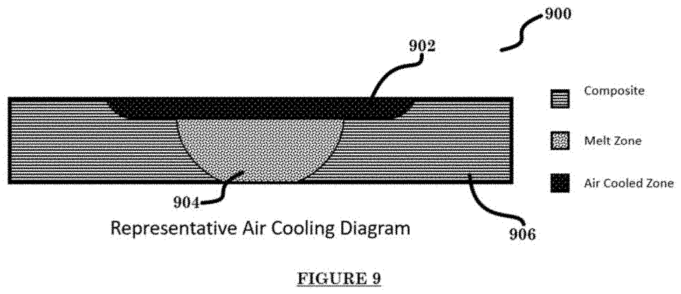

In a further embodiment, see FIG. 3, a method of vacuum assisted induction welding 300 is provided. At step 302, the pieces to be welded together are joined to form a weld area. At step 304, the weld area is surrounded by a vacuum bag. At step 306, a vacuum is created at the weld area by evacuating all gases from the vacuum bag in order to form a vacuum seal. At step 308, an induction coil is passed over the weld area, in a preferred embodiment, the induction coil does not contact the weld area. At step 310, while the induction coil is passing over the weld area, the weld area is actively cooled via an air flow. Air flow may cover an entire heated zone and extend beyond the zone prevent melting of surface. See FIG. 9, which shows a representative air cooling diagram 900 of the current disclosure. Air cooled zone 902 may extend laterally beyond melt zone 904 of composite 906. The angles of application for the air flow are dependent on apparatus supplying cooling air. Air cooling is supplied until composite temperature has fallen below the melt temperature. At step 312, the induction coil is removed from the weld area and welding is complete. The induction coil may be passed over the composite using either manual or automated processes.

The invention provides a method for simple and economical positioning of two work pieces with each other. Once positioned a weld can be created using induction heating to melt the polymer in the composite. Air can be blown on the surface to limit the welding to an area close to the mating surface of the work pieces and preventing melting of the outer surface which would deteriorate the quality of the outer surface. The current disclosure lowers the nonrecurring costs associated with thermoplastic welding, enables welding of more complex parts, and simplifies the overall weld process. In one aspect, the current process allows for welding of composites without the use of fixed tooling. Fixed tooling is limited to single geometry type, whereas vacuum bag can be applied to many different layup tool geometries. Vacuum bagging also reduces the number or tooling parts required as layup tools also can serve as the welding tooling. The pressurization method is further simplified by the elimination of the necessity for pressure bladders. Match die tooling is always expensive. Allowing one of the dies to be flexible (the vacuum bag) will reduce cost and also risk: in case work piece thicknesses change, a vacuum bag can handle this. Matched dies will need to be modified or scrapped.

The vacuum bagging of the current disclosure is an alternative for the KvE based welding procedure in which the work piece is compressed on two sides with a solid. Further, active cooling of the bag with air allows high Tg/Tm polymer based composites to be welded with a low grade bag material. The principle of air cooling while heating works because induction heating is used. With induction, heat is generated within the laminate. Heating the material in an oven, platen press or autoclave requires heat travelling from the outside of the laminate inwards. Cooling would than directly annihilate the ingoing heat.

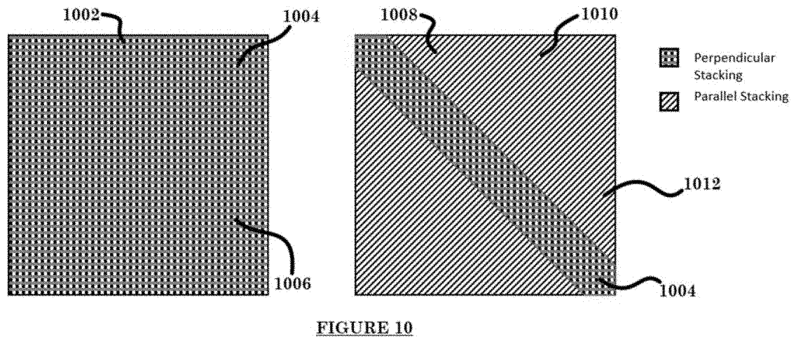

In a further embodiment, tuning the stacking sequence within the laminate or adding films of polymer to increase the distance between fibers in two adjacent plies can be used to focus the induction based heat generation towards the surfaces that need to be welded. Perpendicular stacking of plies produces maximum heating, parallel stacking produces minimum heating. See FIG. 10, which shows tuning of a stacking sequence to focus heating as well as focused heated in perpendicular stacking. As FIG. 10 shows, at 1002 perpendicular stack 1004 may be employed across a laminate surface 1006 to promote uniform heating across laminate surface 1006. 1008 shows that parallel stacking 1010 may be employed with perpendicular stacking 1004 across a second laminate surface 1012.

Films may be used to isolate portions of the composite from heating due to separation distance between the fibers. If the distance between the fibers in two adjacent plies is increased by adding a pure polymer layer between those plies, the heating will no longer take place at that location. Of course there will still be conduction but the induction heating will stop. This gives a possibility to steer the heating more to the welding zone, especially when combined with external cooling by blowing air. In principle: the outer surfaces can be kept cold while the surfaces at the weld surface can be heated. Possible applications of the current disclosure include welding of plates, ribs to skins, skins to skins etc.

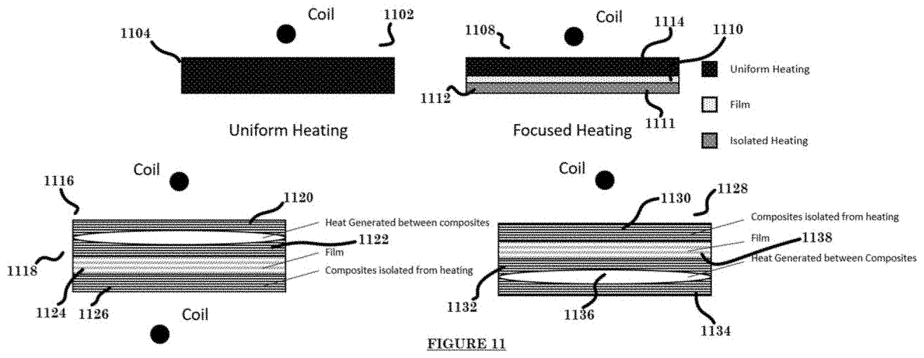

FIG. 11 shows various examples of how the process of the current disclosure may be employed to create different heating profiles, while these specific profiles are illustrated further profiles and combinations of the illustrated profiles are considered within the scope of the disclosure. At 1102 a uniform heating profile occurs when a laminate is heated entirely through the laminate body 1104. At 1106, an example of focused heating 1108 is shown where a film 1110 causes isolated heating 1111 in lower portion 1112 of laminate 1114. At 1116, an example of isolation heating 1118 is demonstrated wherein heat may be generated between composites 1120 and 1122 to weld same and isolation film 1124 separates unheated composite 1126 from heating to prevent heating in this composite. At 1128, an example is shown where composite closest to the coil 1130 does not undergo heating but first lower composite 1132 and second lower composite 1134 are welded 1136 due to presence of barrier film 1138 that prevents heat from weld 1136 from reaching 1130.

The current disclosure may be used to consolidate stacks of thermoplastic prepreg. So one may use the technique to consolidate laminates under a vacuum bag. Thus, the technique may be used as a primary or secondary consolidation step for composite thermoplastic structure. For example, a preform of CFRTP can be made on an AFP machine. A post processing step using induction heating can be applied with the preform now covered with a vacuum bag, to have a second flow of polymer to achieve full consolidation and/or fill/smoothen gaps and overlaps in case of non-single-curved parts created with AFP. This will allow for the full consolidation of laminates without the use of Autoclave to facilitate Out Of Autoclave (OOA) processing. There is a desire in industry to do AFP of thermoplastic composites and obtain full consolidation while doing the AFP process. This is very hard if not impossible to achieve when the surface being laid up on is double curved. This will create gaps and overlaps in the plies and between plies. The gaps need to be filled up. This requires a second melt step. This can be created by running a coil over the surface and use induction heating to bring the material back in the melt and use a vacuum bag to push or pull the polymer into the gaps. Air may be blown on the vacuum bag, not directly on the work piece since this is covered by the bag. Preferably air flow is directed to the location of the induction coil over the work piece(s). Air flow covers the melt zone to prevent damage to the bagging material. The air flow can be stationary or moving with respect to the induction coil.

Penetration depth as defined for metals is not of much importance for composites. A composite is not heating at the outer surface but at material close to ply interfaces where the fiber direction changes. By choosing a proper stacking sequence, the heat generation can be mostly at the mating surface between the two work pieces and not at the outer surface closes to the induction coil.

Further, while ferromagnetic materials are referenced for the case welding of non-conductive fiber based composites using a metallic susceptor, the current disclosure is not so limited and non-ferromagnetic materials may be employed. Further, the current disclosure may be used with composites. The current embodiment may also be used for consolidating preforms made from co-mingled flat materials or co-mingled braids. Further, one or both work pieces may contain susceptors as required by the welding design. Other suitable suspectors include metal meshes, metal strips, carbon fibers, etc., as known to those of skill in the art. Suitable metals may include, but are not limited to, nickel, cobalt, copper, steel, chromium, aluminum, etc.

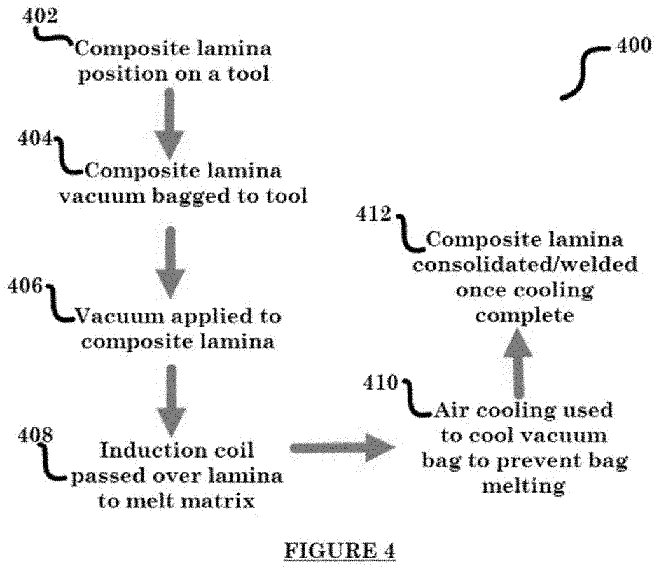

FIG. 4 shows a further embodiment of a welding and consolidation process 400. At step 402, composite lamina/laminates are positioned on a tool. Composite layup tools are used for fabrication of composite parts. Their shape matches the part shape with precision surfaces typically in contact with the tool surface. Tools can be made of various materials including, steel, steel alloys, aluminum, and composites.

At 404, the composite lamina/laminates are vacuum bagged to the tool. Step 406 shows that vacuum is applied to composite lamina/laminates. At step 408, an induction coil is passed over the lamina/laminates to cause melting of the matrix. At step 410, air cooling is used to cool vacuum bag to prevent melting. At step 412, composite lamina/laminates are consolidated/welded once cooling is completed.

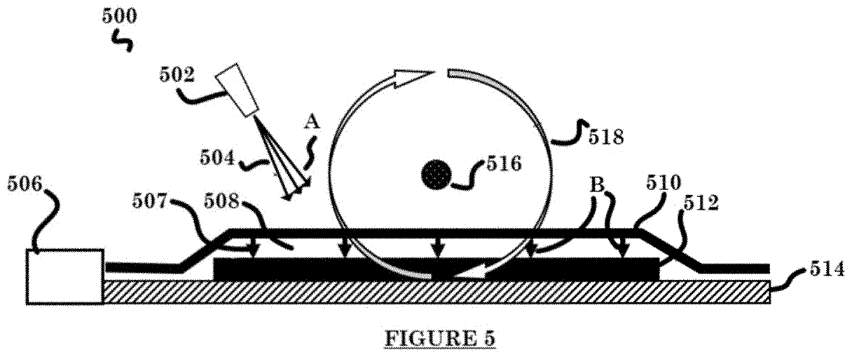

FIG. 5 shows one embodiment of a welding set-up 500 of the current disclosure. Set up 500 includes an air source 502, such as a fan or blower or other way of providing air as known to those of skill in the art, to provide air cooling 504, with air flow shown by arrows A, to set-up 500. Vacuum device 506, which may be any suitable commercially available vacuum source, may impart vacuum pressure 507, shown by arrows B, to interior 508 of an enclosing container 510, which in one embodiment may be a vacuum bag, which covers work pieces 512, which may be composite or laminate, which lays on support surface 514, which may be a tool. Induction coil 516 creates magnetic field 518, which serves to weld composite 512 while composite 512 lays on tool 514.

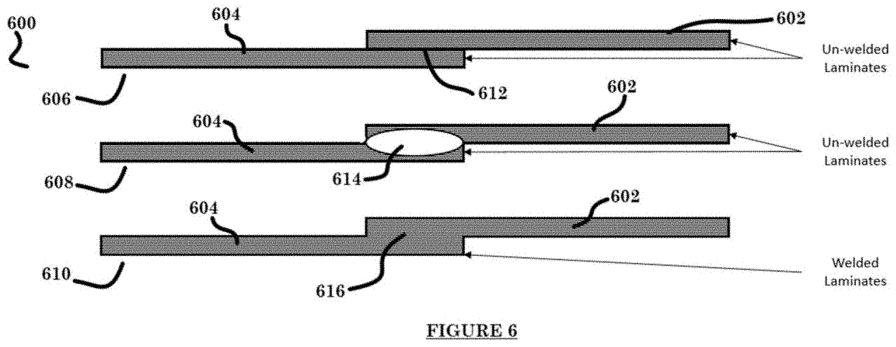

FIG. 6 shows progression 600 of first laminate 602 and second laminate 604 being welded to one another via the process of the current disclosure. At 606, first laminate 602 and second laminate 604 are shown in contact at fusion section 612. At 608, melt zone 614 is formed via welding first laminate 602 to second laminate 604 via an induction coil, not shown. At 610, first laminate 602 and second laminate 604 are now welded to one another at weld 616.

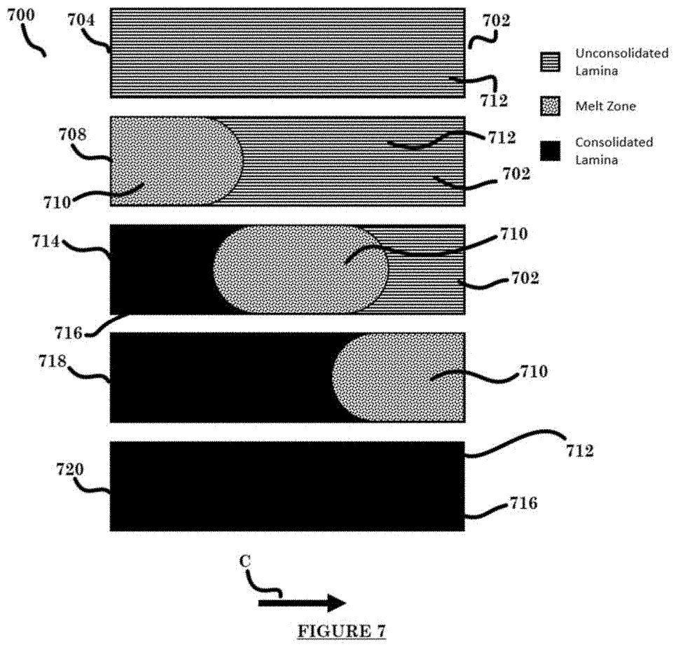

FIG. 7 shows laminate weld progression 700 as the induction coil, not shown, moves across unconsolidated lamina 702 in the direction shown by arrow C. 704 shows unconsolidated lamina 702 while 708 shows melt zone 710 forming in unconsolidated lamina 702 as the induction coil moves in direction C across upper surface 712 of unconsolidated lamina 702. 714 shows consolidated or welded lamina 716 formed after passage of induction coil in direction C as melt zone 710 moves in direction C across upper surface 712 of unconsolidated lamina 702. 718 shows the progression of consolidated or welded lamina 716 across upper surface 712 following melt zone 710 in direction C as the induction coil continues moving over upper surface 712. 720 shows upper surface 712 formed completely of consolidated or welded lamina 716 across the entirety of upper surface 712. While FIG. 7 shows weld progression 700, it should be noted that in one embodiment induction welding of the current disclosure does not change/impact/melt/fuse/distort or otherwise modify the external surface of the work pieces being joined. The external surfaces, accordingly, are unaffected by the induction welding process as welding occurs at the junction of the two or more pieces and does not travel to other areas of the pieces being welded.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A noninvasive method for welding pieces to one another comprising:
placing at least two work pieces in contact with one another;
enclosing an area containing the at least two work pieces;
placing pressure on the at least two work pieces in contact with one another;
induction heating a weld area formed where the at least two work pieces contact one
another; and
blowing air onto a surface of the work pieces.

2. The method of claim 1, wherein an outer surface of the work pieces is unaffected by the welding.

3. The method of claim 1, wherein the pressure is created by forming vacuum pressure in the area containing the at least two work pieces.

4. The method of claim 1, wherein the pressure is generated by enclosing the area containing the at least two work pieces within a container.

5. The method of claim 4, wherein the container is a vacuum bag.

6. The method of claim 1, wherein at least one susceptor is contained within at least one work piece.

7. The method of claim 6, wherein the at least one susceptor may be ferromagnetic or nonferromagnetic.

8. The method of claim 1, wherein an induction coil is moved over the area enclosing the at least two work pieces.

9. The method of claim 8, wherein the induction coil does not come into contact with the weld area.

10. The method of claim 1, wherein a vacuum seal is formed in the area enclosing the at least two work pieces.

11. The method of claim 1, wherein post-weld joined pieces are exposed to a second injunction heating to provide substantially full consolidation.

12. A system for induction welding pieces to one another comprising:
an air source;
a device for creating a vacuum;
an enclosing container;
a support surface; and
an induction coil.

13. The system of claim 12, wherein an outer surface of work pieces being welded to one another is unaffected by induction welding.

14. The system of claim 12, wherein pressure is created by forming vacuum pressure in the enclosing container.

15. The system of claim 12, wherein the enclosing container is a vacuum bag.

16. The system of claim 12, wherein at least one work pieced being welded comprises a susceptor.

17. The method of claim 16, wherein the at least one susceptor comprises a ferromagnetic or nonferromagnetic susceptor.

18. The system of claim 11, wherein the induction coil is moved over the area enclosing the at least two work pieces.

19. The system of claim 11, wherein the induction coil remains at a distance from a weld area formed by the system.

20. The system of claim 11, wherein a vacuum seal is formed in the area enclosing the at least two work pieces.
